(19) United States
(12) Patent Application Publication
(10) Pub. No.: US 2015/0004946 A1
(43) Pub. Date: Jan. 1, 2015

(54) DISPLAYING ALTERNATE MESSAGE ACCOUNT IDENTIFIERS

(71) Applicant: Toyota Motor Engineering & Manufacturing North America, Inc., Erlanger, KY (US)

(72) Inventor: Eric Randell Schmidt, Northville, MI (US)

(21) Appl. No.: 13/932,230

(22) Filed: Jul. 1, 2013

(51) Int. Cl. H04W 4/12; H04L 29/06

(52) U.S. Cl. CPC H04W 4/12; H04L 65/601
USPC 455/412.2

(57) ABSTRACT

A method for displaying alternate account identifiers on a display of a speech recognition and display system includes receiving an account identifier corresponding to a message account associated with a mobile device from the mobile device. The method further includes causing the account identifier to be displayed, receiving a request to display an alternate account identifier, and causing the alternate account identifier for the account to be displayed.

### FIELD

Embodiments provided herein generally describe methods, systems, and vehicles that display message account information on a display device and, more specifically, methods, systems, and vehicles that enable alternate account identifiers to be displayed for message accounts.

### BACKGROUND

Display devices, such as vehicle display devices can be used to display information to users. Information may include navigation data, vehicle system settings, or information provided by a mobile device that is communicatively coupled to the vehicle display device. When the vehicle display device is coupled to a mobile device, users can send and receive messages, make calls, and utilize other mobile device functionality through the via the vehicle display device.

Typically, when a user's mobile device that is coupled to the vehicle display device receives a message (e.g., a text message), the message is transmitted to the vehicle display device to enable the message to be displayed to the user. Because the mobile device may receive messages from various accounts (e.g., a SMS account, a personal email account, a work email account, and the like), the vehicle display device may have a difficult time sorting and presenting the messages to the user in a meaningful way, particularly due to variations in account identifiers that may be provided.

### SUMMARY

In one embodiment, a method for displaying alternate account identifiers is provided. The method includes receiving, from a mobile device, an account identifier corresponding to a message account associated with the mobile device, causing the account identifier to be displayed, receiving a request to display an alternate account identifier, and causing the alternate account identifier to be displayed.

In another embodiment, a system for providing alternate message account identifiers is provided. The system includes one or more processors, one or more memory modules communicatively coupled to the one or more processors, a display, and machine readable instructions stored in the one or more memory modules. When executed by the one or more processors, the machine readable instructions cause the system to receive, from a mobile device, an account identifier that corresponds to a message account, cause the account identifier to be displayed, receive a request to display an alternate account identifier, and cause the alternate account identifier to be displayed instead of the account identifier corresponding to the message account.

In yet another embodiment, a vehicle includes one or more processors, one or more memory modules, and machine readable instructions stored in the one or more memory modules. The machine readable instructions, when executed by the one or more processors, cause the vehicle to receive, from a mobile device via a Bluetooth MAP session connection, an account identifier corresponding to a message account associated with the message device, determine that the account identifier is not suitable, and select an alternate account identifier for display responsive to determining that the account identifier is not suitable.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a vehicle user interface including physical controls, sensors communicating with a processor, and a display device according to one or more embodiments herein;

FIG. 2 illustrates a speech recognition and display system according to one or more embodiments herein;

FIG. 3 illustrates an example method for establishing a connection between a mobile device and an in-vehicle system according to one or more embodiments herein;

FIG. 4 illustrates an example method for opening a MAP session in accordance with one or more embodiments herein;

FIG. 5 depicts an example vehicle user interface according to one or more embodiments herein;

FIG. 6 illustrates an example method for providing alternate account identifiers according to one or more embodiments shown and described herein; and

FIG. 7 depicts an example method for requesting an alternate account identifier in accordance with one or more embodiments herein.

### DETAILED DESCRIPTION

Various embodiments described herein relate to methods, systems, and vehicles for displaying alternate account identifiers for message accounts. In various embodiments, an account identifier corresponding to a message account associated with the mobile device is received from a mobile device. The account identifier can be, for example, provided in response to a request to provide to the speech recognition and display system a list of message accounts associated with the mobile device. In some embodiments, the account identifier is displayed. For example, the account identifier can be displayed on a display unit of the vehicle such that a user can view messages from one or more message accounts on the display unit when the user's mobile device is connected to the vehicle system. In various embodiments, a request to display an alternate account identifier is received. In some embodiments, an alternate account identifier is selected and displayed via the display unit. In some embodiments, a request for a user to provide the alternate account identifier is provided, while in other embodiments, a generic account identifier serves as the alternate account identifier. Various embodiments of the methods, systems, and vehicles for displaying alternate message account identifiers are described in more detail below.

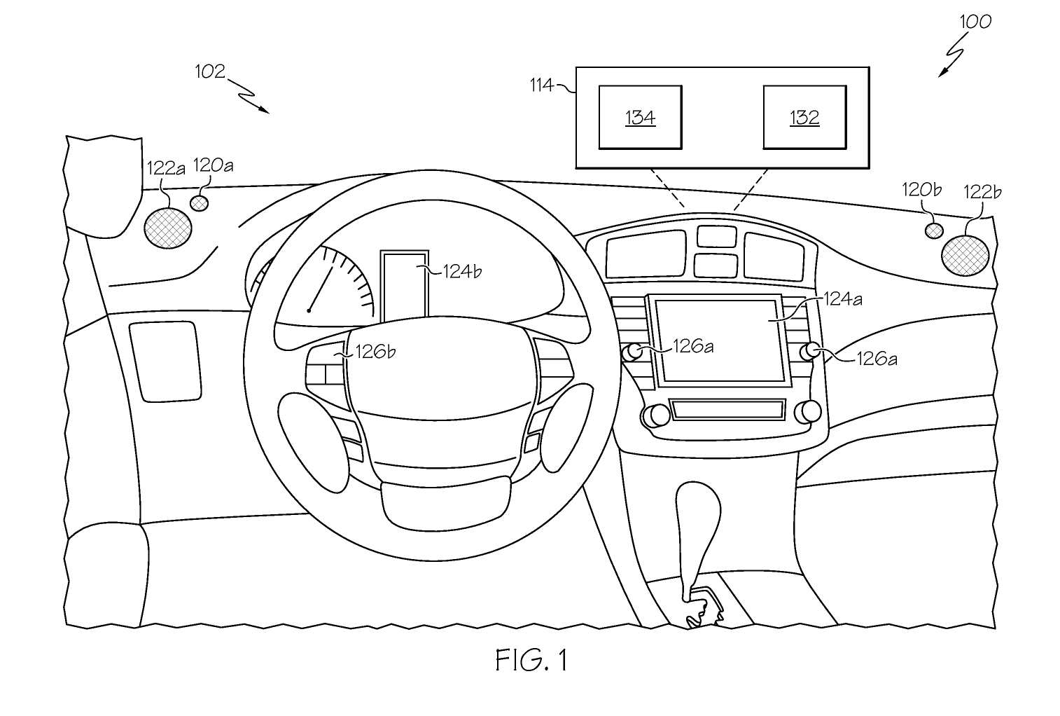

Referring now to the drawings, FIG. 1 schematically depicts a speech recognition and display system 100 in an interior portion of a vehicle 102 for providing a vehicle user interface that includes message information, according to embodiments disclosed herein. As illustrated, the vehicle 102 includes a number of components that can provide input to or output from the speech recognition and vehicle display systems described herein. The interior portion of the vehicle 102 includes a console display 124a and a dash display 124b (referred to independently and/or collectively herein as “display 124”). The console display 124a can be configured to provide one or more user interfaces and can be configured as a touch screen and/or include other features for receiving user input. The dash display 124b can similarly be configured to provide one or more interfaces, but often the data provided in the dash display 124b is a subset of the data provided by the console display 124a. Regardless, at least a portion of the user interfaces depicted and described herein is provided on either or both the console display 124a and the dash display 124b. The vehicle 102 also includes one or more microphones 120a, 120b (referred to independently and/or collectively herein as “microphone 120”) and one or more speakers 122a, 122b (referred to independently and/or collectively herein as “speaker 122”). The microphones 120a, 120b are configured for receiving user voice commands and/or other inputs to the speech recognition systems described herein. Similarly, the speakers 122a, 122b can be utilized for providing audio content from the speech recognition system to the user. The microphone 120, the speaker 122, and/or related components are part of an in-vehicle audio system. The vehicle 102 also includes tactile input hardware 126a and/or peripheral tactile input 126b for receiving tactile user input, as will be described in further detail below.

The vehicle 102 also includes a vehicle computing device 114 that can provide computing functions for the speech recognition and display system 100. The vehicle computing device 114 can include a processor 132 and a memory component 134, which may store message account information.

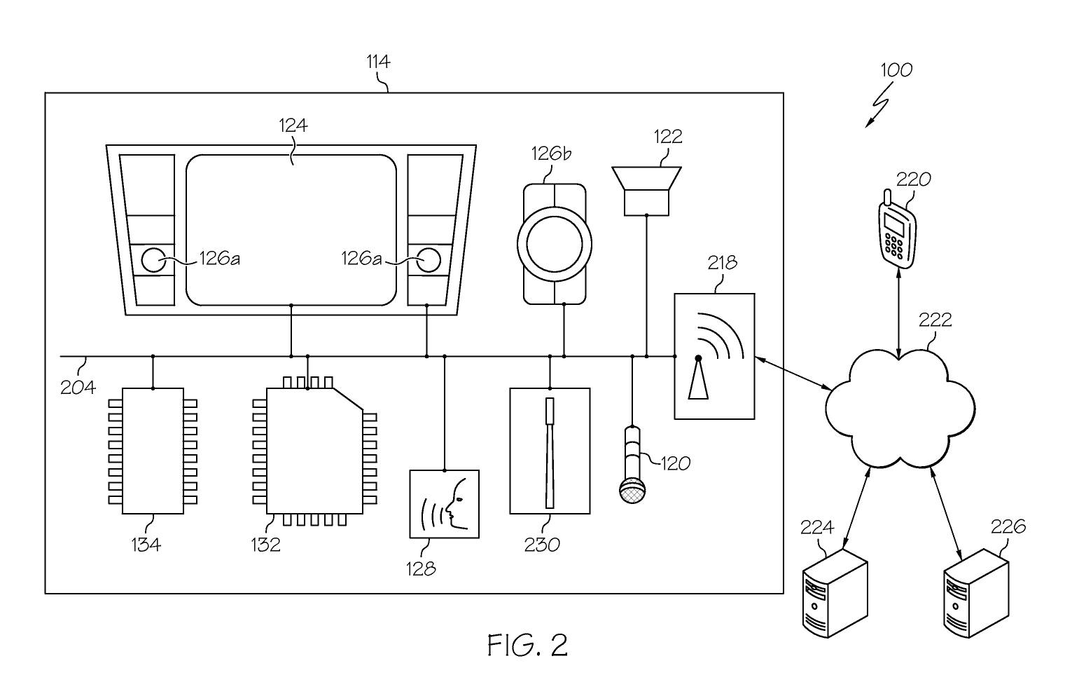

Referring now to FIG. 2, an embodiment of the speech recognition and display system 100, including a number of the components depicted in FIG. 1, is schematically depicted. It should be understood that all or part of the speech recognition and display system 100 may be integrated with the vehicle 102 or may be embedded within a mobile device (e.g., smartphone, laptop computer, etc.) carried by a driver of the vehicle.

The speech recognition and display system 100 includes one or more processors 132, a communication path 204, the memory component 134, a display 124, a speaker 122, tactile input hardware 126a, a peripheral tactile input 126b, a microphone 120, network interface hardware 218, and a satellite antenna 230. The various components of the speech recognition and display system 100 and the interaction thereof will be described in detail below.

As noted above, the speech recognition and display system 100 includes the communication path 204. The communication path 204 may be formed from any medium that is capable of transmitting a signal such as, for example, conductive wires, conductive traces, optical waveguides, or the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. The communication path 204 communicatively couples the various components of the speech recognition and display system 100. As used herein, the term “communicatively coupled” means that coupled components are capable of exchanging data signals with one another such as, for example, electrical signals via conductive medium, electromagnetic signals via air, optical signals via optical waveguides, and the like.

As noted above, the speech recognition and display system 100 includes the processor 132. The processor 132 can be any device capable of executing machine readable instructions. Accordingly, the processor 132 may be a controller, an integrated circuit, a microchip, a computer, or any other computing device. The processor 132 is communicatively coupled to the other components of the speech recognition and display system 100 by the communication path 204. Accordingly, the communication path 204 may communicatively couple any number of processors with one another, and allow the modules coupled to the communication path 204 to operate in a distributed computing environment. Specifically, each of the modules can operate as a node that may send and/or receive data.

As noted above, the speech recognition and display system 100 includes the memory component 134 which is coupled to the communication path 204 and communicatively coupled to the processor 132. The memory component 134 may comprise RAM, ROM, flash memories, hard drives, or any device capable of storing machine readable instructions such that the machine readable instructions can be accessed and executed by the processor 132. The machine readable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable instructions and stored on the memory component 134. Alternatively, the machine readable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

In some embodiments, the memory component 134 includes one or more speech recognition algorithms, such as an automatic speech recognition engine that processes speech input signals received from the microphone 120 and/or extracts speech information from such signals. Furthermore, the memory component 134 includes machine readable instructions that, when executed by the processor 132, cause the speech recognition and display system to perform the actions described below.

Still referring to FIG. 2, as noted above, the speech recognition and display system 100 comprises the display 124 for providing visual output such as, for example, information, entertainment, maps, navigation, messages, or a combination thereof. The display 124 is coupled to the communication path 204 and communicatively coupled to the processor 132. Accordingly, the communication path 204 communicatively couples the display 124 to other modules of the speech recognition and display system 100. The display 124 can include any medium capable of transmitting an optical output such as, for example, a cathode ray tube, light emitting diodes, a liquid crystal display, a plasma display, or the like. Moreover, in some embodiments, the display 124 is a touchscreen that, in addition to providing optical information, detects the presence and location of a tactile input upon a surface of or adjacent to the display. Accordingly, each display may receive mechanical input directly upon the optical output provided by the display 124. Additionally, it is noted that the display 124 can include at least one of the processor 132 and the memory component 134. While the speech recognition and display system 100 is illustrated as a single, integrated system in FIG. 2, in other embodiments, the speech recognition and display systems can be independent systems, such as embodiments in which the speech recognition system audibly provides outback or feedback via the speaker 122.

As noted above, the speech recognition and display system 100 includes the speaker 122 for transforming data signals from the speech recognition and display system 100 into mechanical vibrations, such as in order to output audible prompts or audible information from the speech recognition and display system 100. The speaker 122 is coupled to the communication path 204 and communicatively coupled to the processor 132. However, it should be understood that in other embodiments, the speech recognition and display system 100 may not include the speaker 122, such as in embodiments in which the speech recognition and display system 100 does not output audible prompts or audible information, but instead visually provides output via the display 124.

Still referring to FIG. 2, as noted above, the speech recognition and display system 100 comprises the tactile input hardware 126a coupled to the communication path 204 such that the communication path 204 communicatively couples the tactile input hardware 126a to other modules of the speech recognition and display system 100. The tactile input hardware 126a can be any device capable of transforming mechanical, optical, or electrical signals into a data signal capable of being transmitted with the communication path 204. Specifically, the tactile input hardware 126a can include any number of movable objects that each transform physical motion into a data signal that can be transmitted to over the communication path 204 such as, for example, a button, a switch, a knob, a microphone or the like. In some embodiments, the display 124 and the tactile input hardware 126a are combined as a single module and operate as an audio head unit or an infotainment system. However, it is noted, that the display 124 and the tactile input hardware 126a can be separate from one another and operate as a single module by exchanging signals via the communication path 204. While the speech recognition and display system 100 includes the tactile input hardware 126a in the embodiment depicted in FIG. 2, the speech recognition and display system 100 may not include the tactile input hardware 126a in other embodiments, such as embodiments that do not include the display 124.

As noted above, the speech recognition and display system 100 optionally comprises the peripheral tactile input 126b coupled to the communication path 204 such that the communication path 204 communicatively couples the peripheral tactile input 126b to other modules of the speech recognition and display system 100. For example, in one embodiment, the peripheral tactile input 126b is located in a vehicle console to provide an additional location for receiving input. The peripheral tactile input 126b operates in a manner substantially similar to the tactile input hardware 126a, i.e., the peripheral tactile input 126b includes movable objects and transforms motion of the movable objects into a data signal that may be transmitted over the communication path 204.

As noted above, the speech recognition and display system 100 comprises the microphone 120 for transforming acoustic vibrations received by the microphone into a speech input signal. The microphone 120 is coupled to the communication path 204 and communicatively coupled to the processor 132. As will be described in further detail below, the processor 132 may process the speech input signals received from the microphone 120 and/or extract speech information from such signals.

As noted above, the speech recognition and display system 100 includes the network interface hardware 218 for communicatively coupling the speech recognition and display system 100 with the mobile device 220 or a computer network. The network interface hardware 218 is coupled to the communication path 204 such that the communication path 204 communicatively couples the network interface hardware 218 to other modules of the speech recognition and display system 100. The network interface hardware 218 can be any device capable of transmitting and/or receiving data via a wireless network. Accordingly, the network interface hardware 218 can include a communication transceiver for sending and/or receiving data according to any wireless communication standard. For example, the network interface hardware 218 can include a chipset (e.g., antenna, processors, machine readable instructions, etc.) to communicate over wireless computer networks such as, for example, wireless fidelity (Wi-Fi), WiMax, Bluetooth, IrDA, Wireless USB, Z-Wave, ZigBee, or the like. In some embodiments, the network interface hardware 218 includes a Bluetooth transceiver that enables the speech recognition and display system 100 to exchange information with the mobile device 220 (e.g., a smartphone) via Bluetooth communication.

Still referring to FIG. 2, data from various applications running on the mobile device 220 can be provided from the mobile device 220 to the speech recognition and display system 100 via the network interface hardware 218. The mobile device 220 can be any device having hardware (e.g., chipsets, processors, memory, etc.) for communicatively coupling with the network interface hardware 218 and a cellular network 222. Specifically, the mobile device 220 can include an antenna for communicating over one or more of the wireless computer networks described above. Moreover, the mobile device 220 can include a mobile antenna for communicating with the cellular network 222. Accordingly, the mobile antenna may be configured to send and receive data according to a mobile telecommunication standard of any generation (e.g., 1G, 2G, 3G, 4G, 5G, etc.). Specific examples of the mobile device 220 include, but are not limited to, smart phones, tablet devices, e-readers, laptop computers, or the like.

The cellular network 222 generally includes a plurality of base stations that are configured to receive and transmit data according to mobile telecommunication standards. The base stations are further configured to receive and transmit data over wired systems such as public switched telephone network (PSTN) and backhaul networks. The cellular network 222 can further include any network accessible via the backhaul networks such as, for example, wide area networks, metropolitan area networks, the Internet, satellite networks, or the like. Thus, the base stations generally include one or more antennas, transceivers, and processors that execute machine readable instructions to exchange data over various wired and/or wireless networks.

Accordingly, the cellular network 222 can be utilized as a wireless access point by the mobile device 220 to access one or more servers (e.g., a first server 224 and/or a second server 226). The first server 224 and the second server 226 generally include processors, memory, and chipset for delivering resources via the cellular network 222. Resources can include providing, for example, processing, storage, software, and information from the first server 224 and/or the second server 226 to the speech recognition and display system 100 via the cellular network 222. Additionally, it is noted that the first server 224 or the second server 226 can share resources with one another over the cellular network 222 such as, for example, via the wired portion of the network, the wireless portion of the network, or combinations thereof.

Still referring to FIG. 2, the one or more servers accessible by the speech recognition and display system 100 via the communication link of the mobile device 220 to the cellular network 222 can include third party servers that provide additional speech recognition capability. For example, the first server 224 and/or the second server 226 can include speech recognition algorithms capable of recognizing more words than the local speech recognition algorithms stored in the memory component 134. It should be understood that the mobile device 220 may be communicatively coupled to any number of servers by way of the cellular network 222.

As noted above, the speech recognition and display system 100 optionally includes a satellite antenna 230 coupled to the communication path 204 such that the communication path 204 communicatively couples the satellite antenna 230 to other modules of the speech recognition and display system 100. The satellite antenna 230 is configured to receive signals from global positioning system satellites. Specifically, in one embodiment, the satellite antenna 230 includes one or more conductive elements that interact with electromagnetic signals transmitted by global positioning system satellites. The received signal is transformed into a data signal indicative of the location (e.g., latitude and longitude) of the satellite antenna 230 or an object positioned near the satellite antenna 230, by the processor 132. Additionally, it is noted that the satellite antenna 230 can include at least one processor 132 and the memory component 134. In embodiments where the speech recognition and display system 100 is coupled to a vehicle, the processor 132 executes machine readable instructions to transform the global positioning satellite signals received by the satellite antenna 230 into data indicative of the current location of the vehicle. While the speech recognition and display system 100 includes the satellite antenna 230 in the embodiment depicted in FIG. 2, the speech recognition and display system 100 may not include the satellite antenna 230 in other embodiments, such as embodiments in which the speech recognition and display system 100 does not utilize global positioning satellite information or embodiments in which the speech recognition and display system 100 obtains global positioning satellite information from the mobile device 220 via the network interface hardware 218.

Still referring to FIG. 2, it should be understood that the speech recognition and display system 100 can be formed from a plurality of modular units, i.e., the display 124, the speaker 122, the tactile input hardware 126a, the peripheral tactile input 126b, the microphone 120, etc. can be formed as modules that when communicatively coupled form the speech recognition and display system 100. Accordingly, in some embodiments, each of the modules can include at least one processor 132 and/or the memory component 134. Accordingly, it is noted that, while specific modules may be described herein as including a processor and/or a memory module, the embodiments described herein can be implemented with the processors and memory modules distributed throughout various communicatively coupled modules.

Having described in detail a speech recognition and display system that can be used to implement one or more embodiments, consider the following methods providing alternate account identifiers for message accounts.

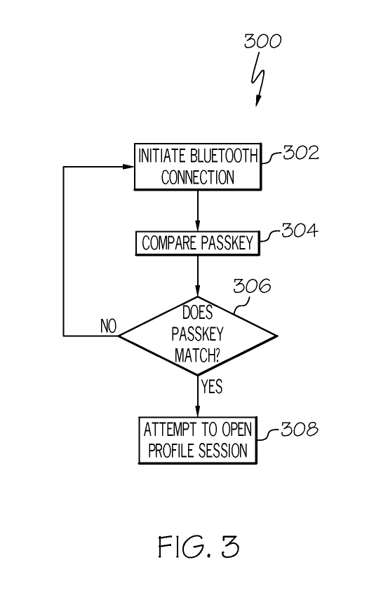

Turning now to FIG. 3, an example method 300 for communicatively coupling the mobile device 220 and the speech recognition and display system 100 via a Bluetooth connection is illustrated.

First, at block 302, a Bluetooth connection between the mobile device 220 and the speech recognition and display system 100 is initiated. For example, the mobile device 220 can initiate a search for an available Bluetooth device, such as the speech recognition and display system 100. In some embodiments, the mobile device 220 initiates the connection automatically, while in other embodiments, the mobile device 220 initiates the connection in response to receiving user input. For example, the user can access a Bluetooth connection menu and indicate that a connection should be initiated.

Next, passkeys are compared (block 304). For example, the speech recognition and display system 100 can have a passkey or pairing code that enables the user to connect the mobile device 220 to the speech recognition and display system 100. In some embodiments, the user is prompted to input the passkey, while in other embodiments, the passkey was previously stored.

If the passkeys do not match (a no at block 306), the method can return to block 302 and attempt to initiate another Bluetooth connection. For example, if the user inputs a passkey into the mobile device 220 that does not match the passkey for the speech recognition and display system 100, the connection between the mobile device 220 and the speech recognition and display system 100 will not be established, and the mobile device 220 can attempt to initiate another connection automatically or in response to input from the user. In some embodiments, the user is prompted to re-enter the passkey.

However, if the passkey does match (a yes at block 306), the Bluetooth connection is established, and the speech recognition and display system 100 can attempt to open one or more profile sessions (block 308). Any number of profile sessions can be opened to allow exchange of information between the mobile device 220 and the speech recognition and display system 100 to enable various functions (e.g., messaging, calling, etc.) to be performed. For example, the Phone Book Access Profile (PBAP) allows exchange of phone book objects between devices. Phone book objects represent information about one or more contacts stored by the mobile device 220. Such a profile can allow the speech recognition and display system 100 to display a name of a caller when an incoming call is received, and to download the phone book so that the user can initiate a call from the display 124. As another example, the Message Access Profile (MAP) allows exchange of messages between the mobile device 220 and the speech recognition and display system 100. MAP can enable users to read messages (e.g., SMS messages, emails, and the like) on the display 124 and create messages using the speech recognition and display system 100.

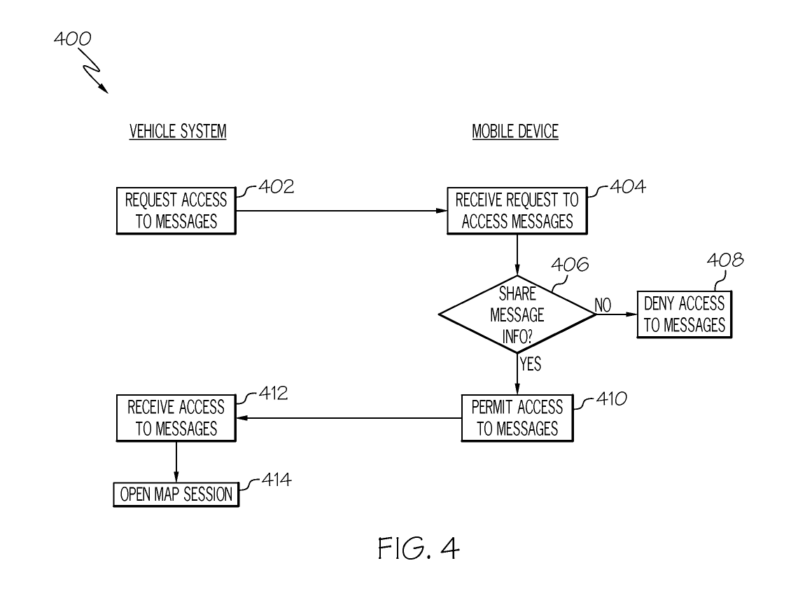

FIG. 4 illustrates an example method 400 for opening a MAP session. As illustrated in FIG. 4, the method 400 includes various functions that are performed by the speech recognition and display system 100, and various functions that are performed by the mobile device 220. In some embodiments, however, functions can be performed by either of the speech recognition and display system 100 or the mobile device 220.

Once a Bluetooth connection is established, the speech recognition and display system 100 requests access to messages (block 402). The request is received by the mobile device 220 (block 404), and the mobile device 220 determines if message info is to be shared (block 406). In some embodiments, the mobile device 220 can prompt the user to confirm that message information can be shared with the speech recognition and display system 100. When message information is not to be shared (a no at block 406), the mobile device 220 can deny the speech recognition and display system 100 access to messages (block 408). In some embodiments, the mobile device 220 can transmit a denial message to the speech recognition and display system 100, while in other embodiments, the mobile device 220 can simply not permit access to the speech recognition and display system 100.

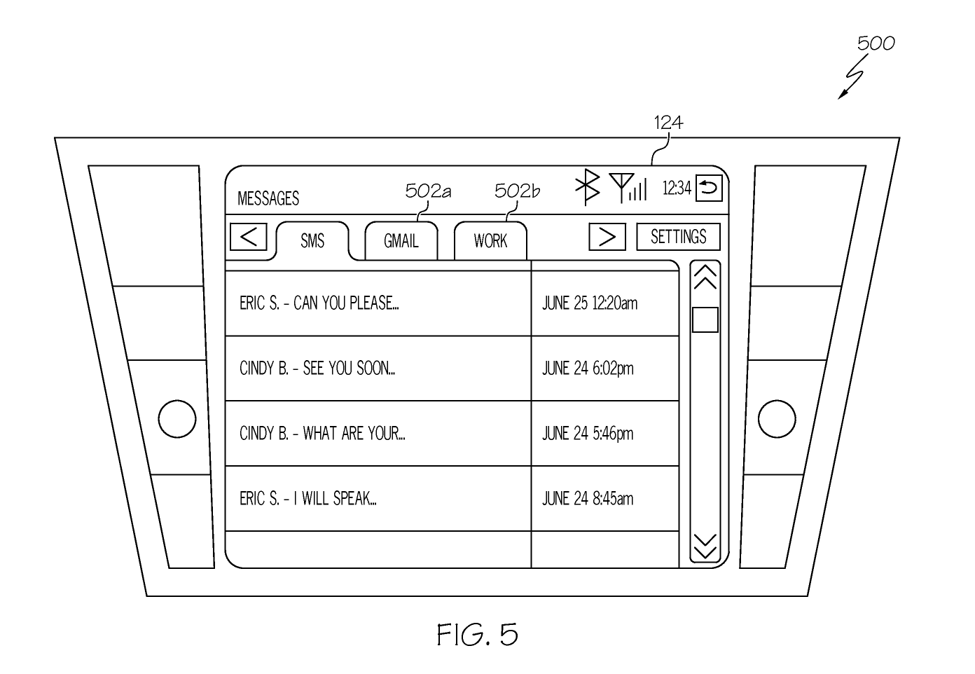

However, if the mobile device 220 determines that message information is to be shared (a yes at block 406), the mobile device 220 permits access to messages (block 410). The speech recognition and display system 100 receives permission to access messages (block 412) and opens a MAP session (block 414). The MAP session enables the mobile device 220 and the speech recognition and display system 100 to send and receive messages. Once a MAP session is opened, messages received by the mobile device 220 via one or more message accounts can be accessed and displayed by the speech recognition and display system 100. For example, the speech recognition and display system 100 can display messages received by the mobile device 220 on the display 124, as shown in FIG. 5.

In FIG. 5, an example vehicle user interface 500 is illustrated. The vehicle user interface 500 can be, for example, an interface provided by the speech recognition and display system 100. The vehicle user interface 500 is displayed on the display 124 and enables users to view messages that are received by the mobile device 220 that is communicatively coupled to the speech recognition and display system 100. In various embodiments, multiple message account tabs, such as account tab 502a and account tab 502b (collectively, “message account tabs 502”), represent message accounts that can be accessed by the speech recognition and display system 100. The speech recognition and display system 100 may display groups of messages received by the mobile device 220 with message account tabs 502 according to the message account that received the message. For example, the speech recognition and display system 100 can display text messages received by the mobile device 220 under one tab, emails sent to a user's first email account associated with the mobile device 220 under a second tab, emails sent to a user's second email account associated with the mobile device 220 under a third tab, and so on. The message account tabs 502 can be factory-defined and/or customized by the user, as discussed below. Message accounts associated with the mobile device 220 can be accessed by the speech recognition and display system 100 through the MAP session opened in method 400, or according to other suitable connection protocols and methods. The number of message accounts that can be accessed and displayed on the display 124 can vary depending on the particular embodiment.

In each of the message account tabs 502, an account identifier can be displayed to indicate a message account with which the messages displayed in the tab are associated. For example, the message account tab 502a includes the account identifier “Gmail,” and messages sent to the user's Gmail account are displayed under the message account tab 502a. The message account tab 502b includes the account identifier “Work,” and messages sent to the user's work email account are displayed under the message account tab 502b. The account identifier displayed in each of the message account tabs 502 can be selected according to one or more embodiments described herein. The speech recognition and display system 100 is able to sort the messages according to account identifier based on information transmitted by the mobile device 220 along with the message according to the particular protocol according to which the message was transmitted.

When a message sent to a message account associated with the mobile device 220 and coupled to the speech recognition and display system 100 is received by the mobile device 220, the mobile device 220 forwards the message to the speech recognition and display system 100. In some embodiments, the message is forwarded in response to a request for messages from the speech recognition and display system 100 (e.g., the speech recognition and display system 100 “pulls” the message), while in other embodiments, the message is forwarded to the speech recognition and display system 100 periodically (e.g., the mobile device 220 “pushes” the message). When the speech recognition and display system 100 receives the message, it stores the message in the memory component 134 along with an associated account identifier. The associated account identifier can be extracted from one or more fields included in the message, depending on the particular protocol according to which the message was transmitted. For example, when the speech recognition and display system 100 and the mobile device 220 are communicatively coupled and messages are shared via a MAP session, each message has a standard format that defines information such as message type, folder properties, application parameters, MAP instance ID, and so on. Thus, when the speech recognition and display system 100 receives a message via the MAP session, it can extract the account identifier from the message. The extracted account identifier enables the speech recognition and display system 100 to present a vehicle user interface in which the messages are sorted according to message account, rather than presenting all messages received by the mobile device 220 in one list.

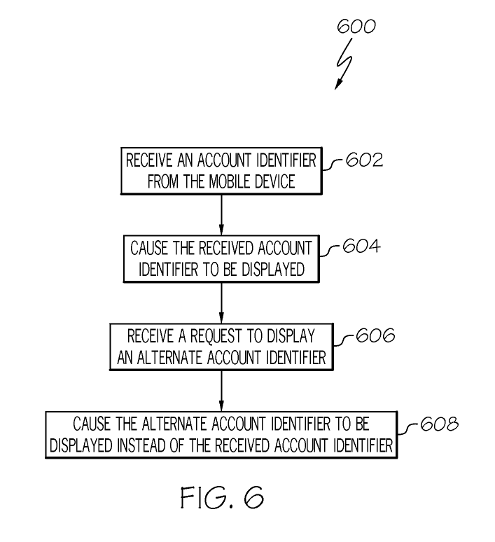

FIG. 6 illustrates an example method 600 for displaying an account identifier on a vehicle user interface in accordance with one or more embodiments. The method can be implemented by any suitable device. In various embodiments, the method 600 is implemented by the speech recognition and display system 100.

First, the speech recognition and display system 100 receives an account identifier that corresponds to a message account associated with the mobile device 220. For example, assume that the speech recognition and display system 100 is communicatively coupled to the mobile device 220 and has an open MAP session. The speech recognition and display system 100 can request a list of accounts associated with the mobile device 220. The mobile device 220 sends information regarding one or more message accounts with which the mobile device 220 is associated, including an account identifier for each message account, to the speech recognition and display system 100. The received message account can be, by way of example and not limitation, an email account, a Short Message Service message (SMS message) account, a Multimedia Message Service message (MMS message) account, a voicemail account, a text message account, or the like.

At block 604, the speech recognition and display system 100 causes the received account identifier to be displayed. In various embodiments, the speech recognition and display system 100 causes the account identifier to be displayed as part of a graphic user interface shown on the display 124. In some embodiments, the account identifier is descriptive of the corresponding message account (e.g., Gmail), while in other embodiments, the account identifier may not be enable the user to determine which message account the account identifier represents. For example, account identifiers received from the mobile device 220 for a user's personal email account and work email account may be too similar for the user to readily distinguish.

When the user does not understand the correlation between the account identifier and the corresponding message account, the account identifier may not be suitable. For example, the speech recognition and display system 100 account identifiers for multiple message accounts associated with the mobile device 220 after opening a session with the mobile device 220, and at least one message account has an associated account identifier of “CMIME_1.” The speech recognition and display system 100 causes “CMIME_1” to be displayed in the message account tab shown on the display 124. The user can indicate that “CMIME_1” is not a suitable account identifier and request that an alternate account identifier be displayed. A user can indicate that an account identifier is not suitable when the account identifier is non-descriptive of the account, when the account identifier is long or complicated, or when the user otherwise prefers that some other account identifier be displayed.

When the account identifier is not suitable, the speech recognition and display system 100 can display an alternate account identifier. The speech recognition and display system 100 may determine that the account identifier is not suitable based on user input. In particular, at block 606, the speech recognition and display system 100 receives the request to display an alternate account identifier. The request can be received, for example, when the speech recognition and display system 100 detects a user input indicative of a request to display an alternate account identifier. The user input can be detected, for example, via touchscreen functionality of the display 124, such as when a user selects a “Change Account identifier” button that is presented on the display 124. In some embodiments, the user input can be received using other user input mechanisms. For example, the speech recognition and display system 100 can detect user input when a user speaks a command to display an alternate account identifier to the system. While receiving the request to display an alternate account identifier is an exemplary mechanism by which the speech recognition and display system 100 determines that the account identifier is not suitable, other mechanisms can be employed.

Alternate account identifiers can be provided in various ways. In some embodiments, the speech recognition and display system 100 can request an alternate account identifier from the mobile device 220 by transmitting a request for an alternate account identifier to the mobile device 220. Additionally or alternatively, the speech recognition and display system 100 can have one or more generic account identifiers (e.g., “Email 1,” “Email 2,” and the like) available as account identifiers. These generic account identifiers can be factory-defined and stored in the memory component 134. As yet another addition or alternative, the speech recognition and display system 100 can cause a request for input of the alternate account identifier to be displayed via the display 124. For example, the speech recognition and display system 100 can prompt the user to provide input corresponding to a user-input alternate account identifier (e.g., “Gmail,” “Work,” and the like). Thus, in some embodiments, the speech recognition and display system 100 can select the alternate account identifier to be displayed from a generic account identifier, a user-input account identifier, and a mobile device-provided account identifier.

Responsive to receiving the request to display an alternate account identifier, at block 608, the speech recognition and display system 100 causes the alternate account identifier to be displayed instead of the received account identifier. Continuing the example from above, “CMIME_1” in the message account tab can be replaced with “Gmail” at block 608. In various embodiments, the speech recognition and display system 100 can associate the alternate account identifier with the received account identifier in the memory component 134. By storing the association, the speech recognition and display system 100 can readily associate messages received from the mobile device 220 that include a particular received account identifier with the alternate account identifier for that message account.

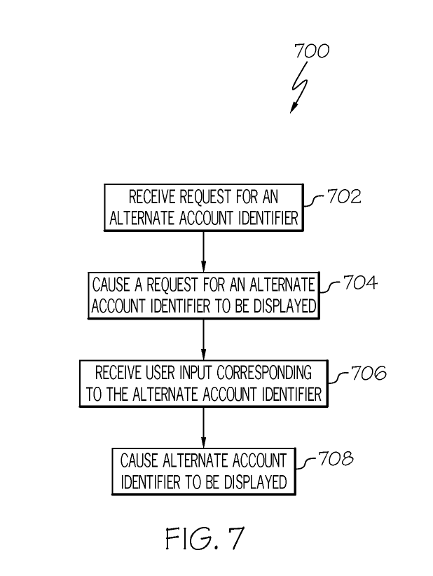

FIG. 7 illustrates an example method 700 for requesting an alternate account identifier to be displayed. First, at block 702, the speech recognition and display system 100 receives a request for an alternate account identifier. The request can be received, for example, from the mobile device 220 or the speech recognition and display system 100 can detect a user input requesting that an alternate account identifier be displayed.

Next, at block 704, the speech recognition and display system 100 causes a request for an alternate account identifier to be displayed. For example, the speech recognition and display system 100 can cause a request to be displayed on the display 124. The user can view the request and provide user input corresponding to the alternate account identifier in various ways. In some embodiments, the user input can be detected using touchscreen functionality of the display 124, while in other embodiments, the speech recognition and display system 100 can receive the user input via the microphone 120 when the user speaks the alternate account identifier.

The speech recognition and display system 100 receives the user input corresponding to the alternate account identifier (block 706) and causes the alternate account identifier to be displayed (block 708). For example, the user-input account identifier can be included in the message account tab displayed on the display 124.

Various embodiments described herein enable the speech recognition and display system 100 to display messages received by the mobile device 220 to users in a way that is meaningful to users. Rather than displaying messages to users according to account identifiers that the occupants cannot readily recognize or associate with a given message account, the speech recognition and display system 100 enables account identifiers to be customized and more user-friendly.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, from a mobile device, an account identifier corresponding to a message account associated with the mobile device;
causing the account identifier to be displayed;
receiving a request to display an alternate account identifier; and
causing the alternate account identifier to be displayed instead of the account identifier corresponding to the message account.

2. The method of claim 1, wherein the alternate account identifier is received from the mobile device.

3. The method of claim 1, wherein the alternate account identifier is a generic account identifier.

4. The method of claim 1, wherein the alternate account identifier is input by a user.

5. The method of claim 1, further comprising:
storing the alternate account identifier.

6. The method of claim 1, further comprising:
responsive to receiving the request to display the alternate account identifier, providing an input request for the alternate account identifier.

7. The method of claim 6, further comprising:
causing an request for input to be displayed; and
receiving user input regarding the alternate account identifier.

8. A system comprising:
one or more processors;
one or more memory modules communicatively coupled to the one or more processors;
a display; and
machine readable instructions stored in the one or more memory modules that cause the system to perform at least the following when executed by the one or more processors:
receive, from a mobile device, an account identifier that corresponds to a message account;
cause the account identifier to be displayed;
receive a request to display an alternate account identifier; and
cause the alternate account identifier to be displayed instead of the account identifier corresponding to the message account.

9. The system of claim 8, wherein the system is communicatively coupled to the mobile device via a Bluetooth MAP session.

10. The system of claim 8, wherein receiving the request comprises detecting a user input indicative of a request to display the alternate account identifier.

11. The system of claim 10, wherein detecting the user input comprises detecting the user input via touchscreen functionality of the display.

12. The system of claim 10, wherein the machine readable instructions further cause the system to perform at least the following when executed by the one or more processors:
responsive to receiving the request to display the alternate account identifier, cause a request for input of the alternate account identifier to be displayed; and
receive the input corresponding to the alternate account identifier.

13. A vehicle comprising:
one or more processors;
one or more memory modules communicatively coupled to the one or more processors; and
machine readable instructions stored in the one or more memory modules that cause the vehicle to perform at least the following when executed by the one or more processors:
receive, from a mobile device via a Bluetooth MAP session, an account identifier corresponding to a message account associated with the mobile device;
determine that the account identifier is not suitable; and
responsive to determining that the account identifier is not suitable, select an alternate account identifier for display.

14. The vehicle of claim 13, further comprising a display; wherein the machine readable instructions further cause the vehicle to perform at least the following when executed by the one or more processors:
cause the alternate account identifier to be displayed via the display.

15. The vehicle of claim 13, wherein determining that the account identifier is not suitable comprises determining that the account identifier is not suitable responsive to receiving a request for the alternate account identifier.

16. The vehicle of claim 15, wherein receiving the request comprises detecting a user input indicative of the request to display the alternate account identifier.

17. The vehicle of claim 16, wherein the user input is detected via a touchscreen of the display.

18. The vehicle of claim 13, wherein selecting the alternate account identifier comprises selecting one of a generic account identifier or a user-input account identifier.

19. The vehicle of claim 13, wherein the machine readable instructions further cause the vehicle to perform at least the following when executed by the one or more processors:
receive a user-input account identifier, wherein selecting the alternate account identifier for display comprises selecting the user-input account identifier.

20. The vehicle of claim 19, wherein the user-input account identifier is received responsive to providing a request for the alternate account identifier.
